(19) United States
(12) Patent Application Publication
(10) Pub. No.: US 2026/0064172 A1
(43) Pub. Date: Mar. 5, 2026

(54) PASSIVELY REGULATING AIRFLOW THROUGH A CARD BRACKET

(71) Applicant: Dell Products, L.P., Round Rock, TX (US)

(72) Inventors: Shree Rathinasamy, Georgetown, TX (US); Jason Rock, Austin, TX (US)

(21) Appl. No.: 18/798,364

(22) Filed: Aug. 8, 2024

(51) Int. Cl. G06F 1/20; G05B 15/02; G06F 1/18

(52) U.S. Cl. CPC G06F 1/206; G05B 15/02; G06F 1/185

(57) ABSTRACT

The described subject matter relates to passively regulating airflow through a vent section of an expansion card bracket. For example, the apparatus can be affixed to a bracket of an expansion card. The apparatus can comprise a moveable plate that can transition along the bracket to cover or expose a vent section of the bracket, causing air flow through the bracket to be either prevented or allowed. Locomotion of the moveable plate can be provided passively as a result of thermal expansion/contraction of a material (e.g., an active auxetic material) that is configured to facilitate the opening or closing of the vent section at specified temperature thresholds of the ambient (e.g., outside) air. The specified temperature thresholds can be specifically configured to temperature operation specifications for elements of the expansion card.

### BACKGROUND

Computing devices such as computers or servers are generally configured with expansion slots into which a card or expansion card can be inserted to thereafter interface directly with the motherboard. Often the expansion cards have ports or interfaces for external connections. For example, a video card can have ports for video input/output (IO), whereas a network interface card (NIC) can have networking jacks or ports. Accordingly, most expansion cards are coupled to a housing of the computing device in a manner that allows the interface ports to be accessed without opening a housing of the computer device. In other words, one side of the bracket is exposed to an external environment. Frequently, potentially along with associated IO ports, certain cards such as NIC cards can have a vent section. This vent section can comprise one or more apertures in the bracket that allow air flow through the bracket, typically resulting in ambient air from the external environment flowing into the interior of the housing.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 depicts an example side view of an exterior face of an expansion card bracket having a vent section to allow air flow through the bracket in accordance with certain embodiments of this disclosure;

FIG. 2 depicts an example schematic block diagram of an example schematic block diagram showing an example device comprising housing that couples to the bracket so that the air flows can pass, via vent section, between an exterior and an interior of the device in accordance with certain embodiments of this disclosure;

FIG. 3 depicts an example NIC card having multiple temperature probes at various locations relative to the vent section and an example graph that plots the temperatures reported by the probes over time in accordance with certain embodiments of this disclosure;

FIG. 4 depicts an example schematic block diagram illustrating a first example apparatus that can passively regulate airflow through a vent section of an expansion card bracket in accordance with certain embodiments of this disclosure;

FIG. 5 depicts an example schematic block diagram illustrating a second example apparatus that can passively regulate airflow through a vent section of an expansion card bracket in accordance with certain embodiments of this disclosure;

FIG. 6 depicts an example schematic block diagram illustrating further detail relating to a representative example of a PTDC device in accordance with certain embodiments of this disclosure;

FIG. 7 illustrates an example method that can provide for passively regulating airflow through a vent section of an expansion card bracket in accordance with certain embodiments of this disclosure;

FIG. 8 illustrates an example method that can provide for additional elements or functionality in connection with passively regulating airflow through a vent section of an expansion card bracket in accordance with certain embodiments of this disclosure;

FIG. 9 illustrates a block diagram of an example distributed file storage system that employs tiered cloud storage in accordance with certain embodiments of this disclosure; and

FIG. 10 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

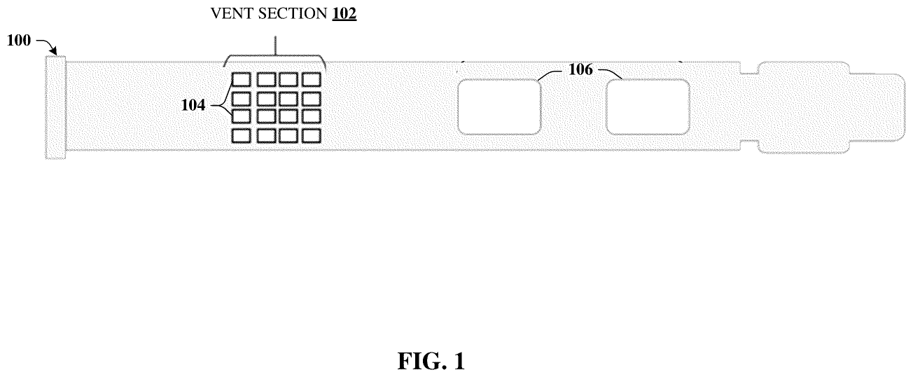

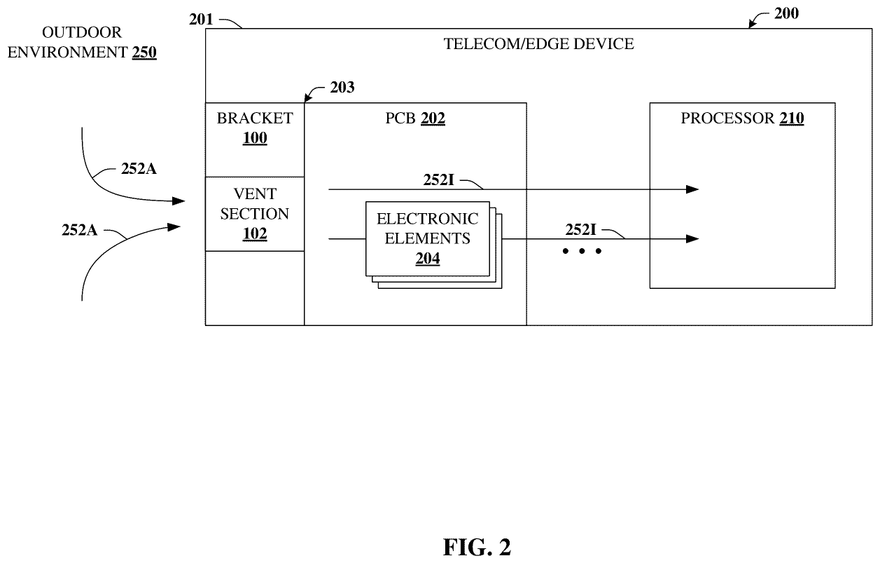

To provide additional context, consider FIGS. 1 and 2. FIG. 1 shows an example side view of an exterior face of a bracket 100, e.g., for an expansion card (e.g., card 203), having a vent section 102 to allow air flow through the bracket 100 in accordance with certain embodiments of this disclosure. FIG. 2 depicts an example schematic block diagram of an example device 200 comprising housing 201 that couples to the bracket 100 so that the air flows can pass, via vent section 102, between an exterior and an interior of the device 200 in accordance with certain embodiments of this disclosure.

As indicated, bracket 100 can be a bracket for card 203, such as an expansion card that is configured to couple to a computing device such as to a motherboard of a server device. The bracket can be configured to secure to a housing (e.g., housing 201) of a computing device (e.g., device 200). As illustrated, bracket 100 can have vent section 102 comprising one or more apertures 104. Apertures 104 can facilitate a flow of air through bracket 100 (e.g., in a direction into or out of the page) between an exterior of the housing 201 to which bracket 100 is coupled and an interior of the housing 201. In some embodiments, bracket 100 can comprise interface ports 106 that can expose connectors such as Ethernet or fiber channel ports or jacks.

As illustrated with respect to FIG. 2, bracket 100 can be coupled to a circuit board such as printed circuit board (PCB) 202. PCB 202 can comprise various electronic elements 204 as well as other components or elements such as fiber optical devices, processing devices (e.g., an application-specific integrated circuit (ASIC)), memory devices, communication devices, heat sinks, interfaces, and so on. Card 203 can be coupled or secured to housing 201 via bracket 100.

The card 203 (e.g., comprising bracket 100) can be any suitable card, but as a representative example, card 203 can be a card that conforms to a peripheral component interconnect express (PCIe) protocol, standard, or form factor, and specifically a PCIe card electromechanical (CEM) protocol, standard, or form factor. As a more specific example, card 203 can be a PCIe CEM network interface card (NIC), another type of NIC, or another suitable type of card. Once bracket 100 is secured to housing 201 and certain electronic elements 204 are seated in an interface slot of device 200 (e.g., a motherboard for device 200), communication can occur between card 203 and the device 200 and/or processor 210 of device 200.

As a representative example, device 200 can be a telecommunications edged device or another suitable device. 5G telecommunications standards was devised in a manner that allows for data center centric equipment with leading-edge integrated circuits to be used not only in the data centers and core networks, but also in edge devices 200 for edge and telecommunications applications. In other words, in accordance with 5G specifications, the same equipment (e.g., card 203) used in a data center can also be deployed in edge devices.

However, one issue that arises is that data centers are often housed in buildings with environment controls (e.g., heating, ventilation, and air conditioning (HVAC) equipment) to regulate the ambient temperature. In contrast, it is customary for edge devices (e.g., device 200) and other telecommunications equipment to reside in outdoor enclosures having unregulated exposure to outdoor environment 250. Hence, most NIC cards or other equipment that was designed to be deployed in a data center having environmental controls is not ordinarily intended to be used without those environmental controls and is not ordinarily configured to handle certain extreme temperatures.

In fact, in a data center environment, the typical concern for equipment is high temperatures. In a data center environment, it is not typically conceivable to deal with subzero temperatures and therefore, most cards 203 are not designed to function at temperatures below zero degrees Celsius (C). Rather, the telecom industry relies on GR-3108-CORE to govern how equipment will operate within those types of environments. GR-3108-CORE device specification accommodates operation in temperatures as low as 40° C. below zero. However, equipment that complies with GR-3108-CORE is more expensive and therefore is not used for data center applications, where such extreme conditions are not expected. Yet, since 5G allows data center cards to be used in the edge deployments, the industry as a whole is moving in that direction. Namely, using data center cards designed for a data center environment (e.g., not in compliance with GR-3108-CORE) in an edge deployment situated in an outdoor enclosure and exposed to outdoor environment 250.

While data center environments are typically concerned with high temperatures, on the other hand, a significant concern for edge devices can arise due to very low temperatures, e.g., below about 0° C. in response to being exposed to outdoor environment 250. While the use of data center computing and optical networking can greatly benefit telecommunications usage, one major hindrance is data center integrated circuits and other equipment are rarely specified to operate below 0° C.

As illustrated in FIG. 2, once an edge device 200 powers up and processor 210 starts generating heat, the internal temperature of device 200 can rise above 0 C, even when outdoor environment 250 is well below that temperature. However, once fans activate to cool processor 210, such operates to draw in air flows 252A through vent section 102 of bracket 100. This subzero ambient air is eventually warmed by processor 210, as shown by internal flows 252I. However, this subzero ambient air first flows across electronic elements 204 of PCB 202.

As a result, the temperature of electronic elements 204, particularly those that are nearest to vent section 102 can drop below 0 C due to air flows 252A. On board ASIC devices and other electronic elements 204 typically cannot operate at temperatures below 0° C., which can occur both whenever processor 210 is not in operation (e.g., prior to startup) or when air flows 252A are drawn in due in part to the operation of processor 210. Even if the temperature is sufficient to allow the ASIC, optics, or other electronic elements 204 to function, operation when near the threshold temperature can degrade the useful life of card 203 and associated electronic elements. That is, operating at 0° C. or a few degrees C above zero can significantly reduce mean time before failure (MTBF) metrics for card 203. Accordingly, it can be advantageous to take steps to prevent the electronic elements 204 of card 203 from operating at temperatures below the threshold temperature

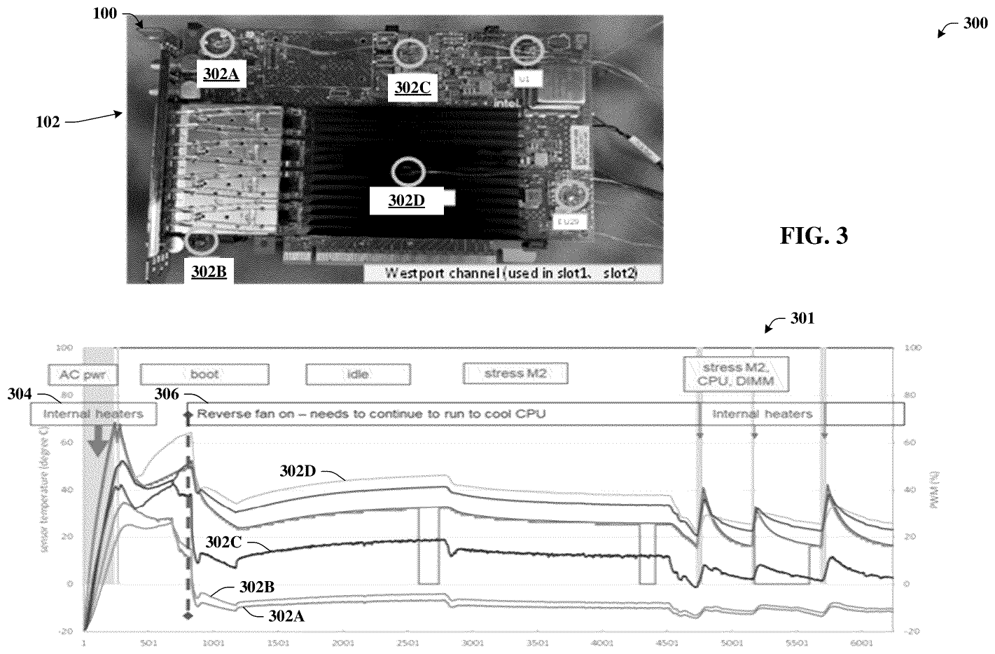

FIG. 3 depicts an example NIC card 203 having temperature probes 302 at various locations relative to the vent section 102 and an example graph 301 that plots the temperatures reported by the probes 302 over time in accordance with certain embodiments of this disclosure.

In this case, the NIC card 203 was fitted with internal heating pads on the back side of the NIC card in an attempt to prevent electronic elements 204 from dropping below 0° C. NIC card 203 was then placed in an edge enclosure where the ambient temperature of outdoor environment 250 was about −20° C. As shown at reference numeral 304, after power was applied, the internal heating pads gradually warmed all portions of NIC card 203 well above 0° C. prior to booting.

However, shortly after booting, as shown at reference numeral 306, reverse fans activated in order to cool processor 210. As shown by graph 301, temperatures reported by probes 302 quickly dropped due to air flows 252A that were drawn in by operation of the cooling fans of processor 210. This temperature drop was more pronounced at the locations of probes 302A and 302B, which are situated closer to vent section 102 and less pronounced but still potentially significant at locations farther away such as at probes 302C and 302D. Hence, areas where the optics ports are located quickly dropped below 0° C. even after being initially heated, regardless of the internal temperature state while processor 210 is active.

For instance, despite processor 210 operating and generating heat for the internal environment, due to −20° C. air flows 252A being drawn in through vent section 102, certain elements of card 203 experienced an average of about −14° C., despite being initially heated prior to boot by internal heaters. Such can cause malfunction, failure, or degradation of card 203. Moreover, internal heating requires external power to operate and time to heat electronic elements 204 prior to booting.

In some cases (e.g., due to a power outage in an area), external power may not be available. Once power is returned, the additional time for heating electronic elements 204 before booting can be costly, particularly given that every second edge device 200 is not in operation (e.g., to route emergency service calls or the like) can be a matter of life or death.

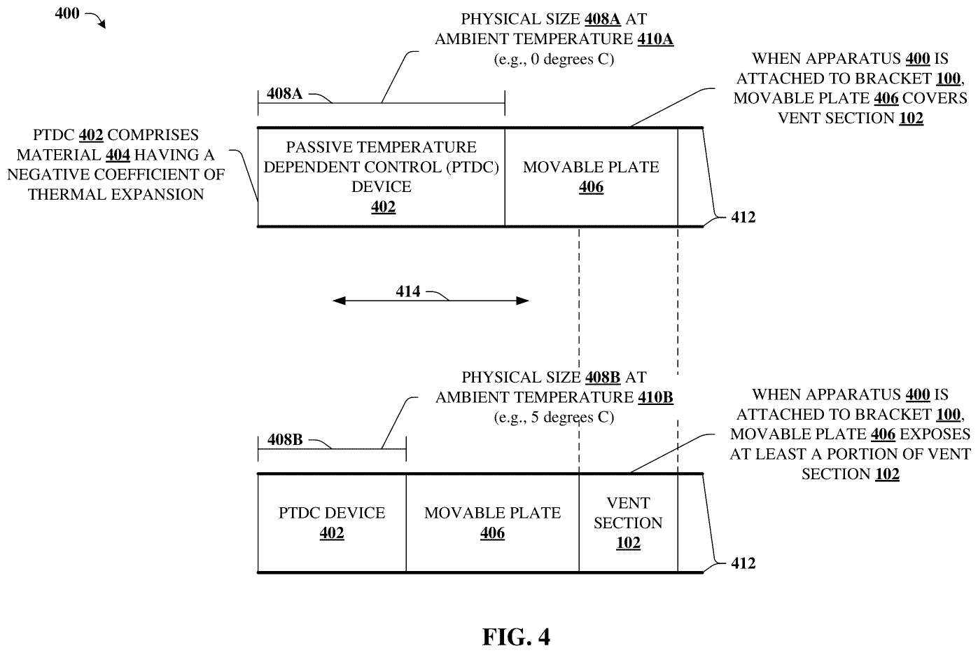

In order to address the foregoing and other related issues, the disclosed subject matter is directed to passively regulating airflow through a vent section of a card bracket. For example, bracket 100 can be fitted with a movable plate that transitions between an open and closed state. For instance, when in the open state, the moveable plate exposes vent section 102 allowing ambient temperature air flows 252A. In the closed state, the movable plate covers vent section 102, preventing air flows 252A from entering through vent section 102. The state of moveable plate can be set passively, meaning that application of power need not be relied upon to change the state of the moveable plate. Hence, the air flow regulation that can aid in preventing some or all portions of card 203 from getting too cold can occur in the absence of power due to a power outage or otherwise. These and other elements or aspects are further detailed in connection with FIGS. 4-8.

### EXAMPLE SYSTEMS

With reference to FIG. 4, an example schematic block diagram is depicted illustrating a first example apparatus 400 that can passively regulate airflow through a vent section 102 of an expansion card bracket 100 in accordance with certain embodiments of this disclosure. In that regard, an upper portion of FIG. 4 illustrates apparatus 400 in a closed state (e.g., covering vent section 102), while the lower portion of FIG. 4 illustrates apparatus 400 in an open state (e.g., exposing vent section 102). It is appreciated that apparatus 400 can be formed, assembled, or coupled to a bracket (not shown, but see, e.g., bracket 100 or FIGS. 1 and 2). In other words, apparatus 400 can be manufactured in conjunction with card 203 or fitted on or otherwise coupled to card 203 post-assembly.

Apparatus 400 can comprise passive temperature dependent control (PTDC) device 402. PTDC device 402 can be coupled to moveable plate 406 by any suitable means or mechanism, or can be a part or PTDC device 402. Movable plate 406 can be configured to transition in a range between a closed state (e.g., the upper portion of FIG. 4) in which movable plate 406 covers vent section 102, preventing the flow of air, and an open state (e.g., the lower portion of FIG. 4) in which movable plate 406 does not cover vent section 102, allowing the flow of air through the bracket 100.

As a consequence of PTDC device 402 being coupled to or including moveable plate 406, PTDC device 402 can operate to change the state (e.g., open or closed) as a function of a physical size 408 of PTDC device 402. For example, in the closed state, physical size 408A differs from physical size 408B causing the closed state. In this example, physical size 408 is represented as a length dimension parallel to an axis of bracket 100 (e.g., axis 414). However, it is appreciated that physical size 408 may include other dimensions as well.

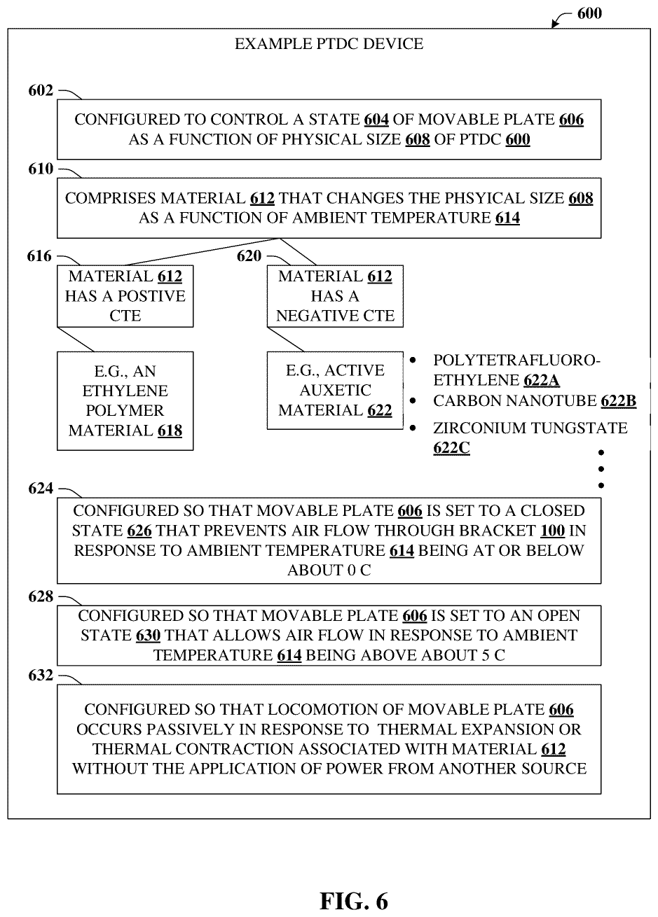

PTDC device 402 can comprise a material 404 that changes physical size 408 of PTDC device 402 as a function of ambient temperature 410. In some embodiments, ambient temperature 410 can be indicative of a temperature of outdoor environment 250 and/or a temperature of air flows 252A. As illustrated, in connection with apparatus 400, material 404 can exhibit a negative coefficient of thermal expansion. In other words, material 404 can be configured to expand when cooled and contract when warmed, which is further detailed in connection with FIG. 6. Thus, at ambient temperature 410A, referred to herein as a threshold temperature (e.g., 0° C.), physical size 408A is large enough such that movable plate 406 covers vent section 102. Hence, at or below ambient temperature 410A, vent section 102 is covered by moveable plate 406 and air flows 252A are prevented from entering and cooling an interior of housing 201.

Alternatively, at ambient temperature 410B, which is greater than ambient temperature 410A (e.g., 5° C., 10° C., . . . ), moveable plate exposes at least a portion of vent section 102 due to material 404 shrinking or contracting. Thus, at or above ambient temperature 410B, at least some apertures 104 of vent section 102 are exposed allowing air flows 252A to enter into an interior of housing 201.

In other words, as the ambient temperature 408 drops, material 404 (and by proxy, PTDC device 402) expands. In response to said expansion, moveable plate 406 transitions in a direction parallel to axis 414 to cover vent section 102 (as shown in the upper portion of FIG. 4). When ambient temperature 408 rises, material 404 (and by proxy, PTDC device 402) shrinks or contracts. In response, moveable plate 406 transitions in the other direction parallel to axis 414 to expose vent section 102 (as shown in the lower portion of FIG. 4). Thus, moveable plate 406 can change state as a function of thermal expansion/contraction of material 404 without relying on actuators or other devices that require power. Hence, apparatus 400 can operate to open or close vent section 102 in a passive manner in the absence of any power supply.

In some embodiments, apparatus 400 can further comprise rails 412, shown here as being parallel to axis 414. Transitions by moveable plate 406 between the open and closed states can be effectuated by sliding along rails 412. In some embodiments, PTDC device 402 can also be constrained by rails 412, e.g., to guide or constrain expansion or contraction of PTDC device 402 and/or to prevent PTDC device 402 from expanding or contracting in a direction perpendicular to axis 414. As also noted, in some embodiments, PTDC device 402 and/or material 404 can be or include moveable plate 406 (e.g., the element that covers or exposes vent section 102).

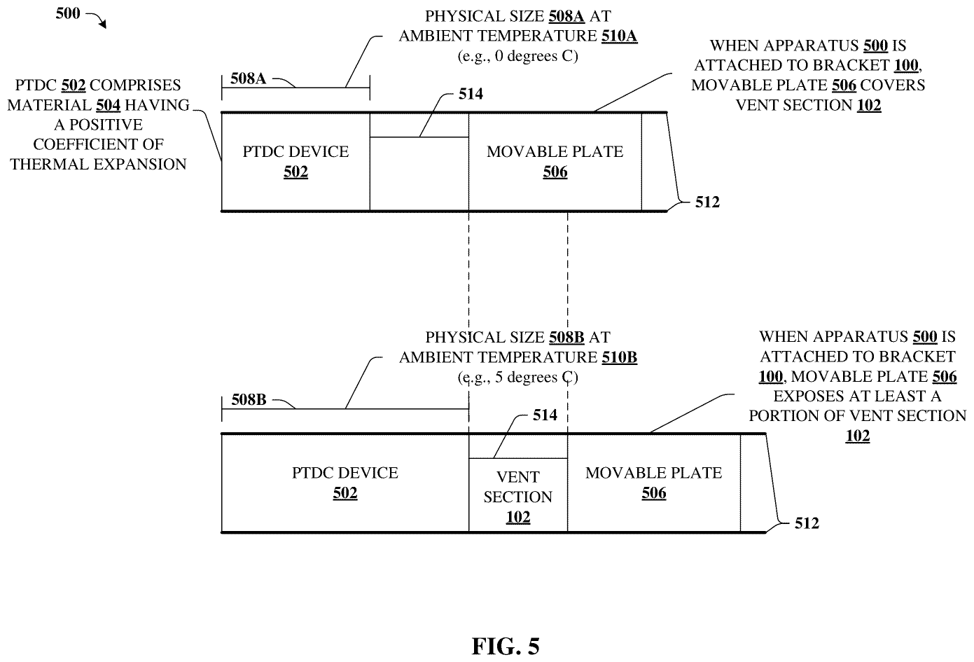

Turning now to FIG. 5, an example schematic block diagram is depicted illustrating a second example apparatus 500 that can passively regulate airflow through a vent section 102 of an expansion card bracket 100 in accordance with certain embodiments of this disclosure. It is appreciated that like reference numerals represent like elements as detailed in FIG. 4.

Apparatus 500 can comprise PTDC device 502 having material 504. In this case, material 504 can have a positive coefficient of thermal expansion and therefore can decrease in physical size 508 as a result of decreasing ambient temperatures 510. In this example, PTDC device 502 is attached to moveable plate 506 via coupler 514. Thus, moveable plate 506 can transition (e.g., along rails 512) to the closed state when ambient temperature 510A is reached. Additionally, moveable plate 506 can transition to the open state in response to ambient temperature 510B, which is greater than ambient temperature 510A, is reached. In some embodiments, a length of coupler 514 can be equal to or greater than a width of vent section 102, in order to allow a fully open state in which all apertures 104 of vent section 102 are exposed.

Based on example illustrations herein, it is understood that different embodiments can exist. For example, material 404 has a negative coefficient of thermal expansion, whereas material 504 has a positive coefficient of thermal expansion. However, in both cases, a physical size 408, 508 of the associated PTDC device 402, 502 can be the mechanism that causes locomotion of the associated moveable plate 406, 506. Thus, PTDC devices 402, 502 can operate passively without application of any other power source (e.g., other than forces due to thermal expansion).

With reference now to FIG. 6, an example schematic block diagram illustrating further detail relating to a representative example of PTDC device 600 in accordance with certain embodiments of this disclosure. PTDC device 600 can include all or a portion of elements or functions detailed in connection with PTDC devices 402 and 502 of FIGS. 4 and 5.

As illustrated at reference numeral 602, PTDC device 600 can be configured to control a state 604 (e.g., open, closed, intermediate) of moveable plate 606 (e.g. moveable plate 406 or 506) as a function of a physical size 608 (e.g., physical size 408 or 508) of PTDC 600. In that regard, as indicated at reference numeral 610, PTDC device 600 can comprise a material 612 (e.g., material 404 or 504) that can change the physical size 608 (e.g., physical size 408 or 508) as a function of ambient temperature 614 (e.g., ambient temperature 410 or 510). Thus, state 604 of moveable plate 606 can be a function of ambient temperature 614 or, in other words, changes in ambient temperature 614 can cause changes in state 604.

As indicated at reference numeral 616, in some embodiments, material 612 can have a positive coefficient of thermal expansion (CTE), such as was detailed in connection with material 504 of FIG. 5. An example can be an ethylene polymer material 618 or another material that exhibits a high CTE.

As indicated at reference numeral 620, in some embodiments, material 612 can have a negative CTE, such as was detailed in connection with material 404 of FIG. 4. An example can be an active auxetic material 622. Representative though non-limiting examples of active auxetic material 622 can be a polytetrafluoroethylene material 622A, a carbon nanotube material 622B, or a zirconium tungstate material 622C.

An auxetic material is a structure or substance that exhibits properties or behavior that is characterized as a negative Poisson's ratio. For example, when stretched or subjected to mechanical stress, the auxetic material expands in one or more perpendicular directions, rather than contracting as most other materials do. Auxetic materials have been studied at least since the early 1900s. More recently, active auxetic materials 622 have been discovered, representing a subset of auxetic materials that can change properties or behavior in response to external stimuli such as temperature or light. As noted earlier, active auxetic material 622 can have a negative CTE and therefore expands as temperatures drop and contracts as temperatures rise.

As indicated at reference numeral 624, PTDC device 600 can be configured so that moveable plate 606 is set to a closed state 626 in response to ambient temperature 614 being at or below about 0° C. In closed state 626, moveable plate 606 can cover vent section 102 of an associated bracket 100 and can prevent air flows 252A through bracket 100. In other words, active auxetic material 622 (and/or PTDC device 600) can be specifically configured to cause closed state 626 at or near temperatures known to cause issues for the proper operation, function, or longevity (e.g., MTBF metrics) of expansion card 203 or associated electronic or optical elements (e.g., electronic elements 204).

In the examples used herein, the threshold temperature is about 0° C. However, with other equipment or with different implementations, the threshold temperature may be different. For example, it may be observed that other expansion cards 203 have degraded performance or longevity below about 5° C. In that case, a threshold temperature of 5 C can be used instead of 0° C. used as representative in the disclosed examples.

As indicated at reference numeral 628, PTDC device 600 can be configured so that moveable plate 606 is set to an open state 630 in response to ambient temperature 614 being above about 5° C. or about 10° C. In open state 630, moveable plate 606 can expose at least a portion of vent section 102 of an associated bracket 100, thus allowing air flows 252A through bracket 100. In other words, active auxetic material 622 (and/or PTDC device 600) can be specifically configured to cause open state 630 at or near temperatures sufficient to avoid issues for the proper operation, function, or MTBF metrics of expansion card 203 or associated electronic or optical elements.

By convention used herein, closed state 626 represents a fully closed state in which all apertures 104 are covered. On the other hand, open state 630 represents a state in which at least some (but not necessarily all) apertures 104 are exposed to allow air flows 252A. However, it is understood that open state 630 could be representative of a fully open state in which all apertures 104 are exposed. Hence, various intermediate states (e.g., partially open) can exist in the latter case. For example, PTDC device 600 (and/or material 612) can be specifically configured to exhibit closed state 626 when ambient temperature 612 is at or below about 0° C., exhibit a (fully) open state 630 at or above 10° C., and to exhibit intermediate (e.g., partially open) states in between.

Furthermore, as indicated at reference numeral 632, PTDC device 600 can be configured so that locomotion of moveable plate 606 occurs passively in response to thermal expansion or thermal contraction associated with material 612. Hence, state 604 can be controlled without the application of power from another source other than the work done on moveable plate due to thermal expansion/contraction of material 612.

### EXAMPLE METHODS

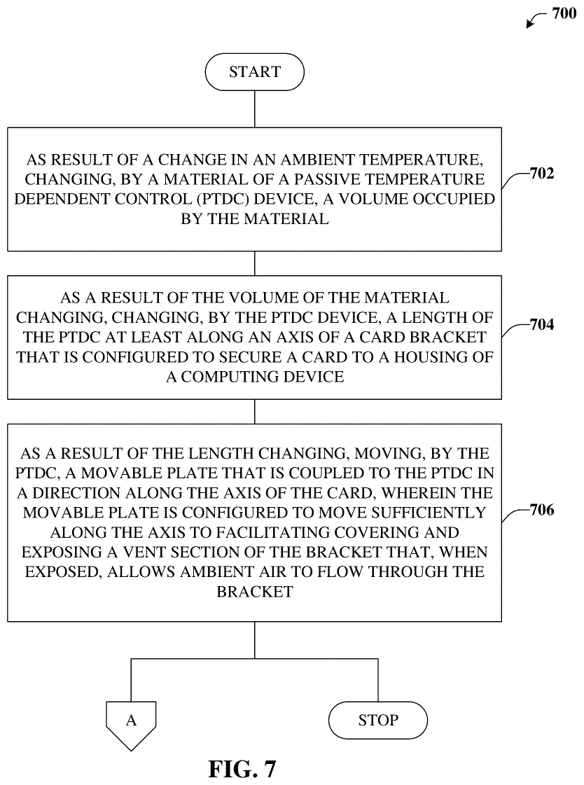

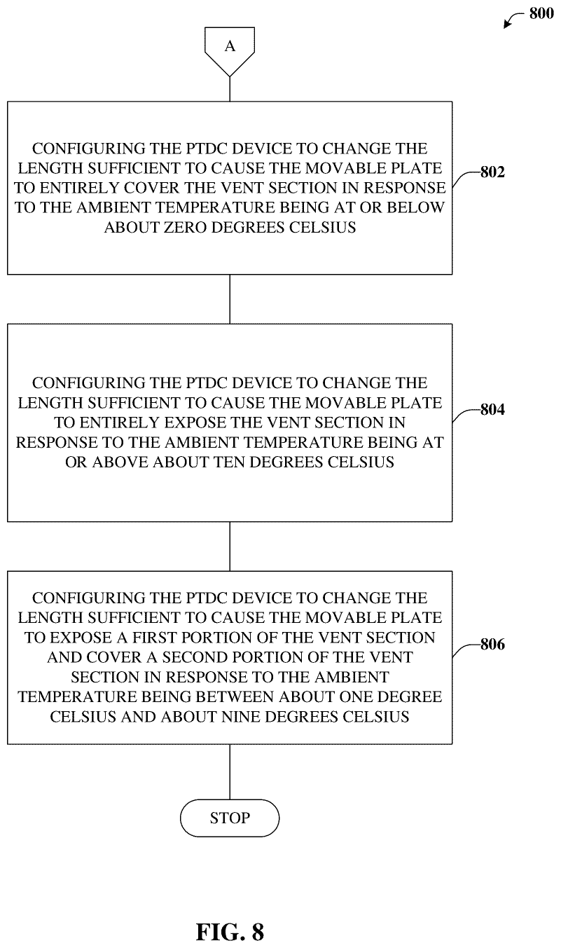

FIGS. 7 and 8 illustrate various example methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Turning now to FIG. 7, example method 700 is depicted. Method 700 can provide for passively regulating airflow through a vent section of an expansion card bracket in accordance with certain embodiments of this disclosure. While method 700 describes a complete method, in some embodiments, method 700 can include one or more elements of method 800, reached via insert A, as discussed at FIG. 8.

At reference numeral 702, as a result of a change in an ambient temperature, a material of a PTDC device can change a volume occupied by the material.

At reference numeral 704, as a result of the volume of the material changing, the PTDC device, can change a length of the PTDC device at least along an axis of a card bracket that is configured to secure a card to a housing of a computing device.

At reference numeral 706, as a result of the length changing, the PTDC device can move a movable plate that is coupled to the PTDC device in a direction along the axis of the card. The movable plate can be configured to move sufficiently along the axis to facilitate covering and exposing a vent section of the bracket that, when exposed, allows ambient air to flow through the bracket. Moreover, the material and/or the PTDC device can be configured to effectuate the sufficient movement of the moveable plate via having a sufficient CTE (e.g., positive or negative). In some embodiments, mechanical amplification techniques can exist such that a first distance moved by the moveable plate can be greater than a second distance representing the amount of thermal expansion/contraction of the material. Method 700 can terminate in some embodiments, or in other embodiments proceed to insert A, which is further detailed in connection with FIG. 8.

Turning now to FIG. 8, example method 800 is depicted. Method 800 can provide for additional elements or functionality in connection with passively regulating airflow through a vent section of an expansion card bracket in accordance with certain embodiments of this disclosure.

For example, at reference numeral 802, the PTDC device introduced in connection with FIG. 7 detailed to passively regulating airflow through a vent section of an expansion card bracket can further be configured to change the length sufficient to cause the movable plate to entirely cover the vent section in response to the ambient temperature being at or below about 0° C. Such can be referred to as a closed state in which ambient air from an outdoor environment is not permitted to enter through the vent section.

At reference numeral 804, the PTDC device can further be configured to change the length sufficient to cause the movable plate to entirely expose the vent section in response to the ambient temperature being at or above about 10° C. Such can be referred to as an open state in which ambient air from an outdoor environment is not prevented from entering through the vent section

A reference numeral 806, the PTDC device can further be configured to change the length sufficient to cause the movable plate to expose a first portion of the vent section and cover a second portion of the vent section in response to the ambient temperature being between about 1° C. and about 9° C. Such can be referred to as an intermediate state in which ambient air from an outdoor environment is permitted to enter through some apertures or portion the vent section, but not other apertures or portions of the vent section.

### EXAMPLE OPERATING ENVIRONMENTS

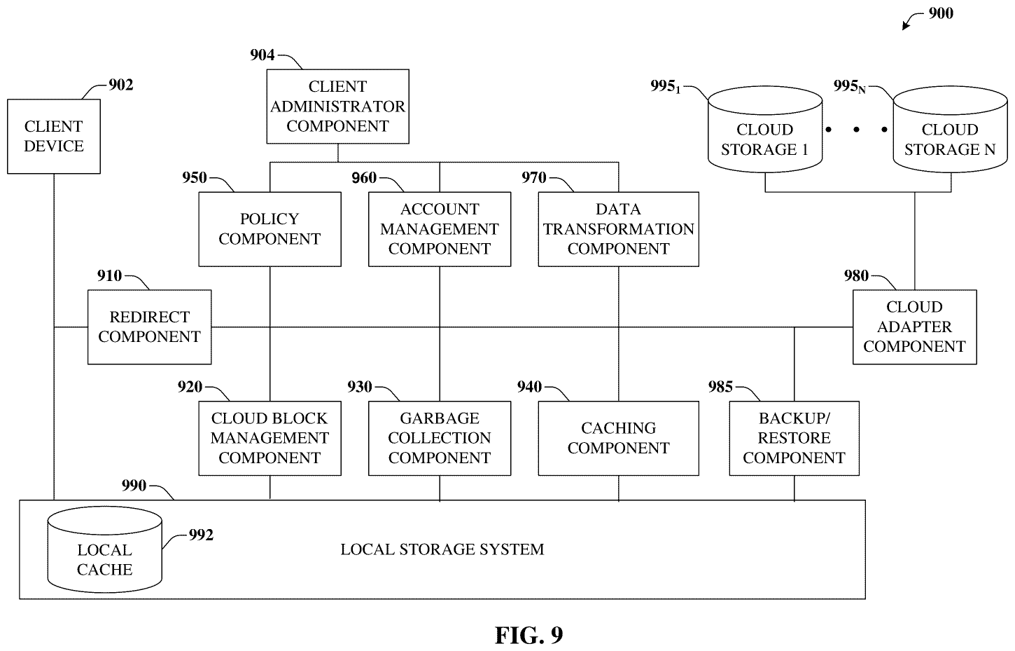

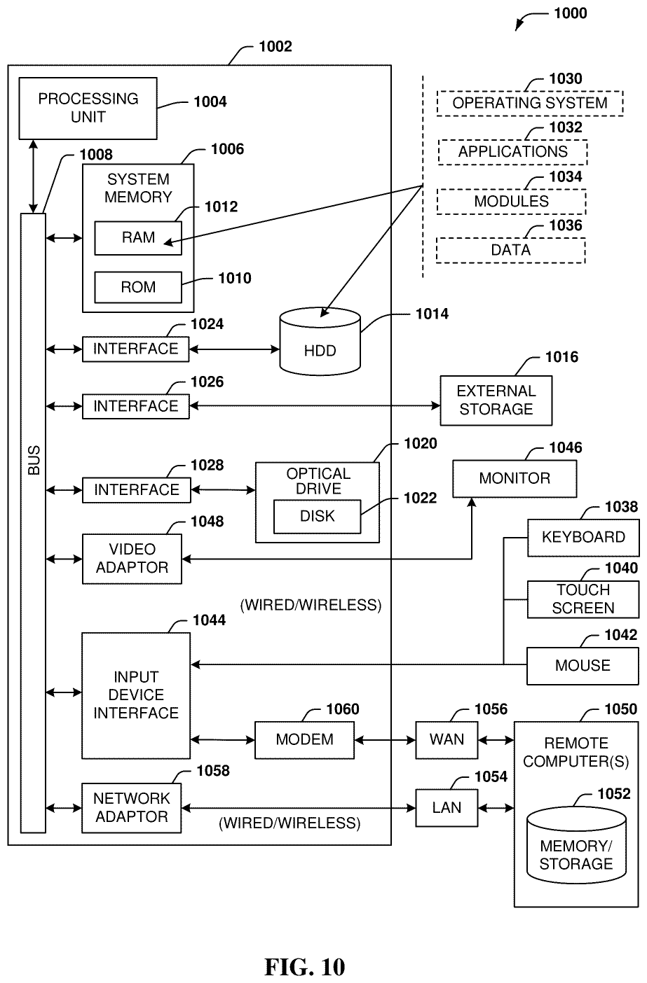

To provide further context for various example embodiments of the subject specification, FIGS. 9 and 10 illustrate, respectively, a block diagram of an example distributed file storage system 900 that employs tiered cloud storage and block diagram of a computer 1002 operable to execute the disclosed storage architecture in accordance with example embodiments described herein.

Referring now to FIG. 9, there is illustrated an example local storage system including cloud tiering components and a cloud storage location in accordance with implementations of this disclosure. Client device 902 can access local storage system 990. Local storage system 990 can be a node and cluster storage system, such as an EMC Isilon Cluster that operates under OneFS operating system. Local storage system 990 can also store the local cache 992 for access by other components. It can be appreciated that the systems and methods described herein can run in tandem with other local storage systems as well.

As more fully described below with respect to redirect component 910, redirect component 910 can intercept operations directed to stub files. Cloud block management component 920, garbage collection component 930, and caching component 940 may also be in communication with local storage system 990 directly as depicted in FIG. 9 or through redirect component 910. A client administrator component 904 may use an interface to access the policy component 950 and the account management component 960 for operations as more fully described below with respect to these components. Data transformation component 970 can operate to provide encryption and compression to files tiered to cloud storage. Cloud adapter component 980 can be in communication with cloud storage 1 995₁ and cloud storage N 995_{N}, where N is a positive integer. It can be appreciated that multiple cloud storage locations can be used for storage including multiple accounts within a single cloud storage location as more fully described in implementations of this disclosure. Further, a backup/restore component 985 can be utilized to back up the files stored within the local storage system 990.

Cloud block management component 920 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 920 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 960 manages the information for cloud storage accounts. Account information can be populated manually via a user interface provided to a user or administrator of the system. Each account can be associated with account details, such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 920 based on a list of mappings that the cloud block management component 920 manages. For example, each stub can be associated with an account, and the cloud block management component 920 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 980 manages the sending and receiving of data to and from the cloud service providers. The cloud adapter component 980 can utilize a set of APIs. For example, each cloud service provider may have provider specific API to interact with the provider.

A policy component 950 enables a set of policies that aid a user of the system to identify files eligible for being tiered to cloud storage. A policy can use criteria, such as criteria that area a function of one or more of file name, file path, file size, file attributes including user generated file attributes, last modified time, last access time, last status change, file ownership, etc. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 930. In another example, caching policies, such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 930 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 940 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 920, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 940 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync.

For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 940 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that the file has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time the stub file is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached; ” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 970 can encrypt and/or compress data that is tiered to cloud storage. In relation to encryption, it can be appreciated that when data is stored in off-premises cloud storage and/or public cloud storage, users can request or require data encryption to ensure data is not disclosed to an illegitimate third party. In one implementation, data can be encrypted locally before storing/writing the data to cloud storage.

In one implementation, the backup/restore component 985 can transfer a copy of the files within the local storage system 990 to another cluster (e.g., target cluster). Further, the backup/restore component 985 can manage synchronization between the local storage system 990 and the other cluster, such that, the other cluster is timely updated with new and/or modified content within the local storage system 990.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information, such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal, such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media, such as acoustic, RF, infrared and other wireless media.

With reference again to FIG. 10, the example environment 1000 for implementing various example embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory, such as ROM, erasable programmable read only memory (EPROM), EEPROM, which BIOS contains the basic routines that help to transfer information between elements within the computer 1002, such as during startup. The RAM 1012 can also include a high-speed RAM, such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the. NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures, such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an example embodiment, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms, such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more example embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or. ” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A card device, comprising:
a printed circuit board comprising electronic parts configured to interface with a computing device; and
a bracket, coupled to the printed circuit board, configured to secure the card device to a housing for the computing device, the bracket comprising:
a vent section comprising one or more apertures that facilitate a flow of air through the bracket between an exterior of the housing and an interior of the housing;
a movable plate configured to transition in a range between a closed state in which the movable plate covers the vent section preventing the flow of air, and an open state in which the movable plate does not cover the vent section allowing the flow of air; and
a passive temperature dependent control (PTDC) device that is coupled to the movable plate and configured to control a state of the movable plate as a function of a physical size of the PTDC device, wherein the PTDC device comprises a material that changes the physical size as a function of an ambient temperature.

2. The card device of claim 1, wherein the material is an active auxetic material having a negative coefficient of thermal expansion, causing the material to increase in size in response to a temperature decrease of the ambient temperature.

3. The card device of claim 2, wherein the active auxetic material is at least one of polytetrafluoroethylene material, a carbon nanotube material, or a zirconium tungstate material.

4. The card device of claim 1, wherein the material has a positive coefficient of thermal expansion, causing the material to decrease in size in response to a temperature decrease of the ambient temperature.

5. The card device of claim 4, wherein the material is an ethylene polymer material.

6. The card device of claim 1, wherein, with respect to the material:
the physical size of the PTDC device corresponds to the closed state of the movable plate when the ambient temperature is at or below a closed state temperature threshold; and
the physical size of the PTDC device corresponds to the open state of the movable plate when the ambient temperature is at or above an open state temperature threshold.

7. The card device of claim 6, wherein the closed state temperature threshold is between about ±2 degrees Celsius.

8. The card device of claim 6, wherein the open state temperature threshold is between about 4-10 degrees Celsius.

9. The card device of claim 6, wherein, with respect to the material, when the ambient temperature is between the open state temperature threshold and the closed state temperature threshold, the physical size of the PTDC device corresponds to an intermediate state of the movable plate that is between the open state and the closed state, resulting in the air flow being restricted for a first portion of the one or more apertures and unrestricted for a second portion of the one or more apertures.

10. The card device of claim 1, wherein the computing device is a telecom edge server situated in an outdoor enclosure.

11. The card device of claim 10, wherein the card device is a network interface card.

12. The card device of claim 10, wherein the card device is a peripheral component interconnect express (PCIe) card electromechanical (CEM) card that conforms to a PCIe CEM connection standard.

13. The card device of claim 1, wherein locomotion of the movable plate occurs passively in response to at least one of a linear thermal expansion or a volumetric thermal expansion associated with the material of the PTDC device without the application of any power.

14. A network interface card (NIC), comprising:
a circuit board comprising electronic elements configured to interface with a server device via a connector that conforms to a peripheral component interconnect express card electromechanical standard; and
a bracket, coupled to the circuit board, configured to secure the NIC to a housing for the server device that is situated in an outdoor environment, the bracket comprising:
a vent section comprising one or more apertures that facilitate a flow of air through the bracket between the outdoor environment and an interior of the housing;
a movable plate configured to transition in a range between a closed state in which the movable plate completely covers the vent section preventing the flow of air, and an open state in which the movable plate does not completely cover the vent section allowing the flow of air; and
a passive temperature dependent controller (PTDC) that is coupled to the movable plate and configured to control a state of the movable plate as a function of a physical size of the PTDC, wherein the PTDC comprises an active auxetic material that changes the physical size as a function of an ambient temperature in accordance with a negative coefficient of thermal expansion.

15. The NIC of claim 14, wherein with respect to the active auxetic material:
the physical size of the PTDC corresponds to the closed state of the movable plate when the ambient temperature is at or below about zero degrees Celsius; and
the physical size of the PTDC corresponds to the open state of the movable plate when the ambient temperature is above about zero degrees Celsius.

16. The NIC of claim 14, wherein locomotion of the movable plate occurs passively in response to thermal expansion associated with the active auxetic material of the PTDC without the application of power from another source.

17. A method, comprising:
as result of a change in an ambient temperature, changing, by a material of a passive temperature dependent control (PTDC) device, a volume occupied by the material;
as a result of the volume of the material changing, changing, by the PTDC device, a length of the PTDC device at least along an axis of a card bracket that is configured to secure a card to a housing of a computing device;
as a result of the length changing, moving, by the PTDC device, a movable plate that is coupled to the PTDC device in a direction along the axis of the card, wherein the movable plate is configured to move sufficiently along the axis to facilitating covering and exposing a vent section of the bracket that, when exposed, allows ambient air to flow through the bracket.

18. The method of claim 17, further comprising configuring the PTDC device to change the length sufficient to cause the movable plate to entirely cover the vent section in response to the ambient temperature being at or below about zero degrees Celsius.

19. The method of claim 17, further comprising configuring the PTDC device to change the length sufficient to cause the movable plate to entirely expose the vent section in response to the ambient temperature being at or above about ten degrees Celsius.

20. The method of claim 17, further comprising configuring the PTDC device to change the length sufficient to cause the movable plate to expose a first portion of the vent section and cover a second portion of the vent section in response to the ambient temperature being between about one degree Celsius and about nine degrees Celsius.
